(19) United States
(12) Patent Application Publication
(10) Pub. No.: US 2003/0016840 A1
(43) Pub. Date: Jan. 23, 2003

(54) Developmental device for use during and after pregnancy

(76) Inventor: Kimberly A. Sica, Ravenna, OH (US)

Correspondence Address: Heather M. Barnes, Fourteenth Floor, One Cascade Plaza, Akron, OH, 44308, US

(21) Appl. No.: 09/908,258

(22) Filed: Jul. 18, 2001

(51) Int. Cl. H04R 5/02; H04R 1/02; H04R 9/06

(52) U.S. Cl. 381/333; 381/301

(57) ABSTRACT

The present invention is a developmental device for use during and after pregnancy and comprises an elongated, elasticized belt, having a soft, looped fabric on both sides. The developmental device also comprises at least one speaker disposed within the belt. A playback device selectively attaches to the belt and is in electronic communication with the speaker. The playback device further comprises at least one preprogrammed microchip for transmitting an electrical signal to the speakers. A recordable microchip may also be included in the playback device to record a personalized message for the unborn child.

### I. BACKGROUND OF THE INVENTION

A. Field of Invention

The present invention relates to apparatuses and methods for a developmental device for use during, and after, pregnancy. More specifically, the present invention relates to apparatuses and methods for a belt comprising speakers and a playback unit for playing audible output to a fetus developing in a woman's womb or to a baby subsequent to birth.

B. Description of the Related Art

In the art of prenatal development, it is well known that a fetus is capable of detecting and discerning audible input as soon as twenty-six weeks after development in the womb. Studies further show that certain classical music, such as selections composed by Mozart, Hayden, Bach and Beethoven, has positive neurological and psychological effects on the developing fetus. Scientific studies support the notion that playing classical music to a baby may increase the baby's intellectual capacity. Babies who have had classical music played to them during gestation have been found to have higher I.Q.'s, higher creativity, and greater linguistic skills. It has also been shown that newborn babies who were familiar with classical music during development in the womb, are easily comforted or quieted when the same music is played for them once they are outside the womb.

In another application of this theory, fetuses can become familiar with their loving parents' voices if the parents speak to the baby during pregnancy. When the baby is born, they have already become familiar with their mother and/or father's voice and have formed a bond with the mother and father.

Developmental devices for use during pregnancy have often taken the form of garments or belts. While these devices suit their intended purpose, they each have one common drawback. All of these devices utilize a standard cassette player, CD player, and/or radio receiver in order to transmit audio signals to the speakers disposed within the belt or garment. Having these developmental devices attached to the garment or belt may cause the player to be continually bumped if the expectant mother is constantly in motion. Further, due to the size of known players, the weight distribution of the entire device is not evenly distributed about the mother's body. Uneven distribution of weight cause back pain or discomfort in other areas if the device is worn for a significant amount of time.

Therefore, there exists a need in the art for a developmental device for use during and after pregnancy that utilizes an audio playback device that is lightweight so that an expectant mother can wear the developmental device for a prolonged period of time without experiencing discomfort.

### II. SUMMARY OF THE INVENTION

The present invention is a developmental device for use during and after pregnancy and comprises an elongated, elasticized belt, having a soft, looped fabric on both sides. The developmental device also has at least one speaker disposed within, or outside of, the belt. A playback device selectively attaches to the belt. The playback device is in electronic communication with the speaker. The playback device further comprises at least one microchip for transmitting an electrical signal to the speakers. Accordingly, it is an object of the present invention to provide a developmental device for use during pregnancy that utilizes a lightweight playback device so as to provide a substantially even distribution of weight about the expectant mother's body.

Another object of the present invention is to provide a developmental device for use during and after pregnancy wherein at least one microchip is preprogrammed.

Yet another object of the present invention is to provide a developmental device for use during and after pregnancy, wherein the preprogrammed microchip comprises at least one song.

Further, another object of the present invention is to provide a developmental device for use during and after pregnancy, wherein the preprogrammed microchip comprises at least one nature sound.

Still yet, another object of the present invention is to provide a developmental device for use during and after pregnancy, wherein the preprogrammed microchip comprises a heartbeat sound.

Another object of the present invention is to provide a developmental device for use during and after pregnancy, wherein the microchip is adapted to record audible input.

Further, another object of the present invention is to provide a developmental device for use during and after pregnancy, wherein the playback device further comprises a microphone for recording the audible input to the microchip.

Still yet, another object of the present invention is to provide a developmental device for use during and after pregnancy, wherein said belt has a first end and a second end, where the first end is adapted to attach to the second end such that said belt is snugly fit around the woman's abdomen and the first end attaches to the second end in an associated hip area of the woman.

Another object of the present invention is to provide a developmental device for use during and after pregnancy, wherein the playback device further comprises an external speaker such that once the baby is born, it can hear the same familiar sounds it heard while developing in the womb.

Yet, another object of the present invention is to provide a developmental device for use during and after pregnancy, wherein the playback device further comprises a jack for receiving earphones.

Further yet, another object of the present invention is to provide a developmental device for use during and after pregnancy, wherein the playback device further comprises a LCD display for monitoring the audio selection and volume control of the playback device.

Another object of the present invention is to provide a developmental device for use during and after pregnancy, wherein the playback device is no more than approximately two inches in length and no more than approximately two inches in width.

Still, another object of the present invention is to provide a developmental device for use during and after pregnancy, wherein the elongated belt comprises a width and a length where the width is no more than approximately two inches and the length is approximately forty-five inches.

Further, another object of the present invention is to provide a developmental device for use during and after pregnancy, wherein said audio playback device is selectively attachable to the elongated belt.

Other objects and advantages of the invention will appear from the following detailed description of the preferred embodiment of the invention with reference being made to the accompanying drawings.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is perspective view illustrating the present invention.

FIG. 2 is a front view of the playback device of the present invention.

FIG. 3 is a rear view of the playback device of the present invention.

FIG. 4 is side view of the present invention attaching to the hip area of an expectant mother.

FIG. 5 is a top view of the first surface of the belt.

FIG. 6 is a top view of the second surface of the belt.

### IV. DESCRIPTION OF THE PREFERRED EMBODIMENT

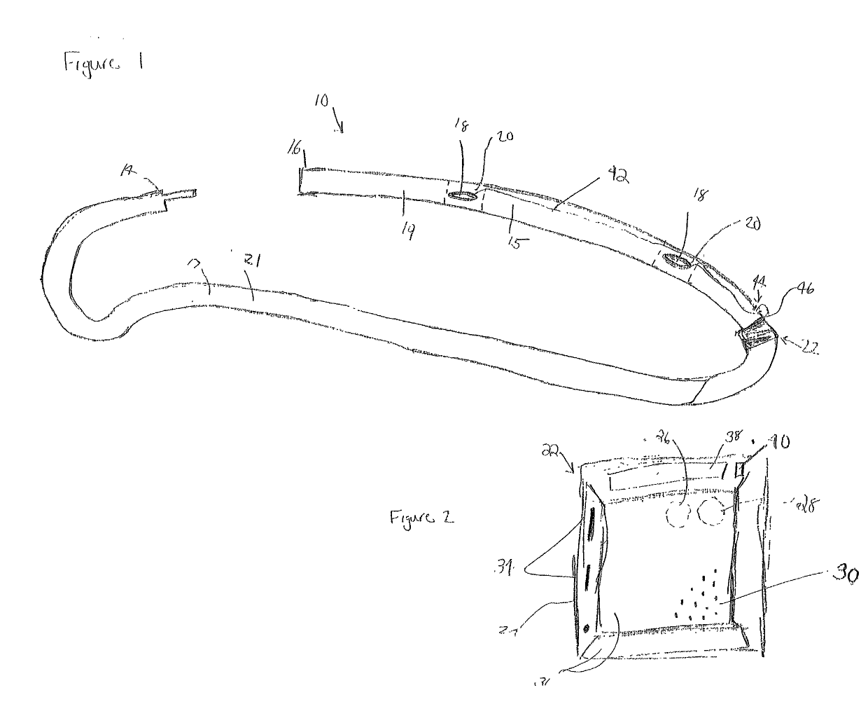

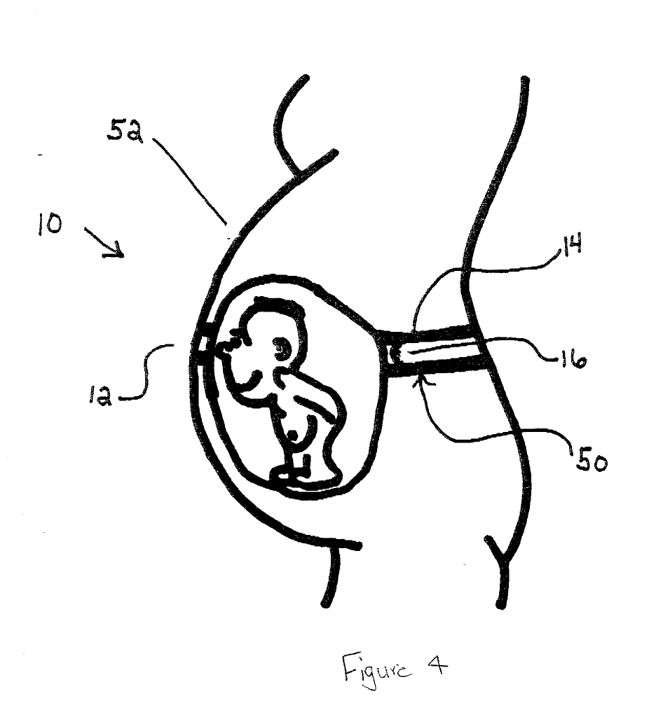

Referring now to the drawings wherein the showings are for purposes of illustrating a preferred embodiment of the invention only and not for purposes of limiting the same, FIGS. 1-6 depict various views of the present invention. The present invention encompasses a developmental device for use during and after pregnancy 10. The developmental device comprises an elongated, elasticized belt 12 having a first end 14 and a second end 16. The first end 14 is adapted to attach to the second end 16 of the belt 12, resulting in engaged and disengaged positions. The first end 14 may attach to the second end 16 through a hook and loop material, such as VELCRO®, a registered trademark of Velcro USA, Inc., Manchester, N.H. Of course other fasteners may be utilized to engage the belt ends 14, 16, such as, but not limited to, a buckle, snaps, or buttons. The belt 12 may also comprise two bands 19, 21 joined together through any conventional method, such as by sewing or VELCRO®. The belt also comprises first and second surface 15, 17, which should be fabricated from a soft, looped fabric. Of course, any material chosen with sound engineering judgment may be utilized to fabricate the belt 12, but it is preferred that the belt 12 be soft for comfort, and elasticized or stretchable to expand with the woman's abdomen as pregnancy progresses. The belt 12 should be no more than approximately two inches in width and approximately forty-five inches in length. These dimensions provide for a less bulky device and make it easier for the expectant mother to wear the same under clothing.

Reversibility is another feature of the present invention. In the preferred embodiment, the first and second surfaces 15, 17 should be two different colors to designate whether the fetus has been determined to be a boy or a girl. For example, the first surface 15 may be pink and the second surface 17 blue. Alternatively, the belt colors may be blue on the first surface 15 and yellow on the second surface 17, or pink on the first surface 15 and yellow on the second surface 17. Any color combination is contemplated to be within the scope of the present application. For example, if the fetus is a girl, the belt 12 should be worn so that the pink side is facing outward. Likewise, if the fetus is a boy, the belt 12 should be worn so that blue is facing outward.

The belt 12 also comprises pockets 20 to house speakers 18, or alternatively, the speakers 18 may be sewn directly to the belt fabric. The speakers 18 may be selectively disposed within the pockets 20 or within the belt 12. When the speakers 18 are sewn directly to the belt fabric, they may either be sewn between the bands 19, 21 or they may be sewn onto the first and second surfaces 15, 17 of the belt 12.

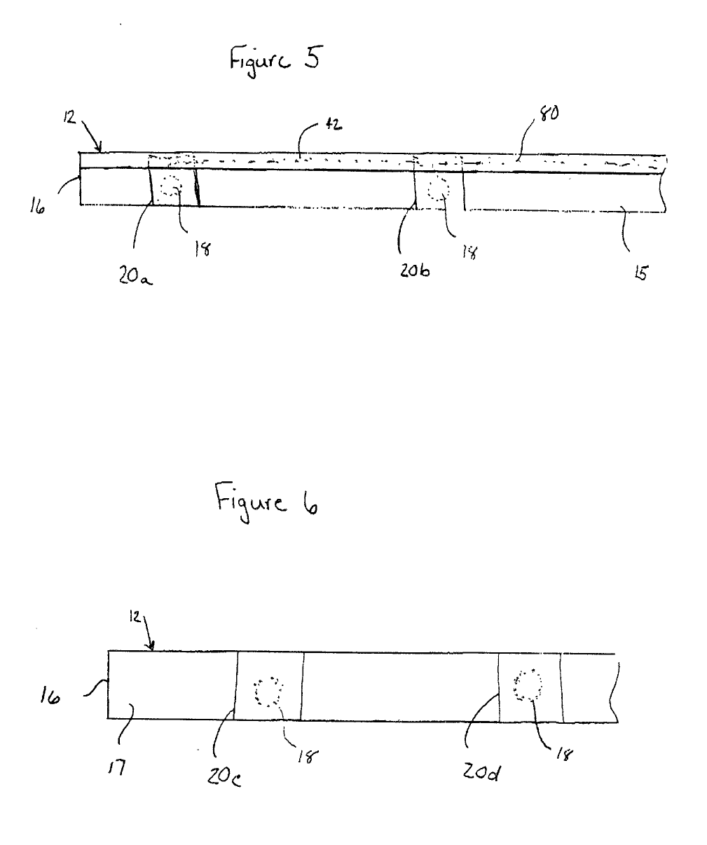

As shown in FIG. 1, the pockets 20 may be an integral part of the belt 12 and should be approximately one inch in height and one inch in width. Instead of being integral with the belt 12, the pockets may be separate from the belt 12 and then attached thereto. As shown in FIGS. 5 and 6, the pockets 20 are formed by separate pieces of material attached to the first and second surfaces 15, 17 of the belt 12, such that the speakers 18 will be selectively disposed outside of the belt 12 into the appropriate pockets 18. To ensure that the speakers 18 maintain their position within the pockets 20, a closure 60 for the pockets 22 may be provided, including without limitation, a small piece of Velcro, buttons, snaps, or an elastic band 62. FIGS. 5 and 6 illustrate two pockets 20a, 20b attached to the first surface 15 and two additional pockets 20c, 20d attached to the second surface 17. This configuration provides for belt reversibility as previously described. Referring to the previous example, if the fetus is a girl, and assuming the first surface 15 is pink, the speakers 18 would be positioned inside the pockets 20c, 20d attached to the second surface 17 of the belt 12. Generally, the pockets 20 maintain the position of the speakers 18 within, or outside of, the belt 12, such that audio signals are transmitted toward the woman's abdomen. Further, the pockets 20 provide the expectant mother with access to remove the speakers 18 in order to launder the belt 12.

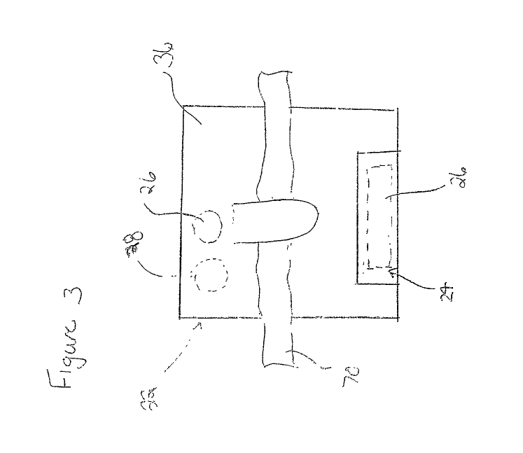

As shown in FIGS. 1 and 2, two speakers 18 may be selectively disposed within the belt 12 to emit sounds towards the expectant mother's abdomen so the developing fetus can hear the same. Regardless of whether the speakers 18 are disposed within pockets 20 formed within the belt 12, or within pockets 20 attached on the surfaces 15, 17 of the belt 12, at least two speakers 18 should be positioned across the abdomen in a spaced relationship, usually about fourteen inches apart. With this configuration, it is believed that the fetus can hear the sounds from any position within the womb.

Continuing to view FIGS. 1 and 2, the speakers 18 are positioned in a spaced relationship relative to each other, but are disposed in approximately the first third to the first half of the belt length. With the speakers 18 positioned in this area, the first and second ends 14, 16 of the belt 12 can engage in the hip area 50 of the expectant mother. Similar devices known in the art attach in the back area of the woman. As pregnancy progresses and the woman's abdomen expands, it becomes more difficult to attach these known devices in the back area without assistance. Therefore, in the present invention, it is desirous for the belt ends 14, 16 to engage in the hip area 50, which is easy to reach during all stages of pregnancy.

As shown in FIGS. 1 and 2, a playback device 22 comprises a power source 24, which may be batteries 26, an AC adapter (not shown), or similar device. The playback device 22 selectively attaches to the belt 12 by a clip 24. In order to provide comfort to the expectant mother, the playback device 22 should be as light as possible so that she does not experience discomfort from uneven weight distribution. In the preferred embodiment, the playback device 22 should be no more than approximately two inches in height and approximately two inches in width. These dimensions allow the expectant mother to wear the developmental device 10 underneath clothing. Accordingly, the expectant mother will be carrying minimal additional weight when wearing the present invention, unlike those developmental devices known in the art, which utilize tape players and CD players. The audio playback device 22 may include at least one preprogrammed microchip 26 and at least one recordable playback chip 28.

The playback device 22 includes other features to allow for versatility to the user. For example, an external speaker 30 is included so that the playback device 22 can be utilized after the baby is born. It is believed that the newborn baby will be comforted when he or she hears the same familiar sounds outside the womb. Another feature of the playback device 22 includes a jack 32 for receiving earphones (not shown). With the earphones, the expectant mother can listen to the same sounds as the developing fetus. Still another feature of the playback device 22 is a control mechanism 34 disposed on an outside surface 36 of the playback device 22 in order to control song selection, volume, and power. As shown in the figures, the control mechanism may take the form of buttons. Although not required, it is preferred that the playback device comprises an LCD display 38 for monitoring the audio selection and volume control.

As shown in FIG. 3, a fabric extension 70 may be utilized to provide extra expansion for the belt 12 and/or to attach the playback device 22 through the clip 24 to an associated crib. The fabric extension 70 should be made from similar material as the belt 12, and should also be provided with VELCRO® to properly attach to the belt 12 or to attach the playback device 22 to the crib.

As previously discussed, numerous studies have found that classical music has positive developmental and psychological effects on the developing fetus. Thus, in the preferred embodiment of the present invention, the preprogrammed microchip 26 should include a plurality of classical musical selections, a plurality of nature sounds, and a heartbeat sound. Of course, any music and/or sounds may be played to the fetus, but it is believed that these sounds would be the most beneficial. The musical selections could be selections, such as but not limited to lullabies, sonatinas, or minuets, composed by various composers, such as Bach, Beethoven, Hayden and/or Mozart, but not limited thereto. The recordable microchip 28 is adapted to record various audible input. Preferably, the audible input may be the voice of the expectant mother and/or father. However, brothers, sisters, other family members or friends may also record messages to be played to the unborn baby. The audible input can be recorded onto the recordable microchip 28 by a microphone 40 included in the playback device 22. One of the advantages of the present invention is that all the musical selections, nature sounds, and the heartbeat sound are available within the playback device 22. Unlike other devices, an external tape cassette or CD is not required. Thus, the playback device 22 of the present invention is far less complex to the user, is easier to use, and eliminates the extra component of the tape cassette or CD.

In order to provide electrical communication between the playback device 22 and the speakers 18, electrical wires or cable 42 may interconnect the speakers 18 to the playback device 22. As shown in FIGS. 1 and 5, the wire 42 should be disposed within the belt 12. The belt 12 may comprise an opening 44 for a plug 46 to fit therethrough. The plug 46 can then be connected to the playback device 22. FIG. 5 illustrates the electrical wire 42 being housed within the belt 12. In this embodiment, the electrical wire 42 attaches to the speakers 18 located in the pockets 18a, 18b attached to the first surface 15 of the belt 12. The belt 12 comprises an overlapping lip 80 having hook material attached thereto. The overlapping lip 80 maintains the position of the wire 42 and fastens to the loop material of the belt 12. Again, this configuration allows for the speakers 18 and wires 42 to be removed for the belt 12 to be laundered. Also, the wires 42 are enclosed within the belt 12 for an aesthetically pleasing appearance and so the wires 42 do not catch on another object that could be encountered in the surrounding environment. It is also contemplated to be within the scope of the present invention for the playback device 22 to be in remote communication with the speakers 18 such that wires 42 are not required. As shown in FIG. 6, the overlapping lip 80 previously described is not required, if the playback device 22 is in remote communication with the speakers 18.

In order to utilize a developmental device for use during and after pregnancy 10, the developmental device as hereinbefore described is provided. The speakers 18 are positioned in the appropriate pockets 20. The belt 12 is wrapped around the expectant mother's abdomen 52. The inner surface 15 of the belt 12 should face the woman's abdomen 52 so that the speakers 18 are positioned inward. The first and second ends 14, 16 of the belt 12 are engaged in the hip area 50 of the woman. With the power source 24 in place, the playback device 22 is activated, and a song, sound, or personal message is selected with the controls 34. An electrical signal is transmitted from the playback device 22 to the speakers 18. The selected song, nature sound, or personal message is then transmitted to the fetus.

While specific embodiments of the invention have been described and illustrated, it is to be understood that these embodiments are provided by way of example only and that the invention is not to be construed as being limited thereto but only by proper scope of the following claims.

What is claimed is:

1. A developmental device for use during and after pregnancy, said developmental device comprising:
a reversible belt having a first surface and a second surface;
a first pocket attached to said first surface;
a second pocket attached to said second surface;
at least one speaker adapted to be selectively disposed within said first pocket, said speaker also adapted to be selectively disposed within said second pocket, said speaker adapted to emit sounds toward a woman's abdomen; and,
an audio playback device communicating with said speaker, said playback device operatively connected to said belt, said playback device comprising at least one microchip for transmitting an electrical signal to said speaker.

2. The developmental device of claim 1, wherein said at least one microchip is preprogrammed.

3. The developmental device of claim 2, wherein said preprogrammed microchip comprises at least one song.

4. The developmental device of claim 2, wherein said preprogrammed microchip comprises at least one nature sound.

5. The developmental device of claim 2, wherein said preprogrammed microchip comprises a heartbeat sound.

6. The developmental device of claim 1, wherein said microchip is adapted to record audible input.

7. The developmental device of claim 6, wherein said playback device further comprises a microphone for recording the audible input to said microchip.

8. The developmental device of claim 1, wherein said belt is elongated and has a first end and a second end, said first end adapted to attach to said second end such that said belt is snugly fit around the woman's abdomen, said first end attaching to said second end in an associated hip area of the woman.

9. The developmental device of claim 1, wherein said belt is stretchable.

10. The developmental device of claim 1, wherein said playback device further comprises an external speaker.

11. The developmental device of claim 1, wherein said playback device further comprises a jack for receiving earphones.

12. The developmental device of claim 1, wherein said playback device further comprises a LCD display for monitoring the audio selection and volume control.

13. The developmental device of claim 1, wherein said playback device is no more than approximately two inches in length and no more than approximately two inches in width.

14. The developmental device of claim 1, wherein said elongated belt comprises a width, said width being no more than approximately two inches.

15. The developmental device of claim 1, wherein said audio playback device is selectively attachable to said elongated belt.

16. A prenatal music belt, comprising:
an elasticized belt adapted to be secured around the abdomen of a woman, said belt being reversible and having a first surface and a second surface;
at least two pockets attached to said first surface;
at least two pockets attached to said second surface;
at least two speakers adapted to be selectively disposed within said two pockets attached to said first surface, said two speakers also adapted to be selectively disposed within said two pockets attached to said second surface;
a playback device selectively attachable to said belt, said playback device being in remote electronic communication with said two speakers, said play back device comprising at least one preprogrammed microchip for transmitting an electrical signal to said speakers.

17. The prenatal music belt of claim 16, wherein said preprogrammed microchip comprises a plurality of musical selections and a plurality of nature sounds.

18. The prenatal music belt of claim 16, wherein said playback device further comprises a programmable microchip for recording an external audio sound, said external audio sound being recorded through a microphone disposed in said playback device.

19. The prenatal music belt of claim 16, wherein said belt comprises two opposing ends, said two opposing ends adapted to be in an engaged and disengaged relationship, said engaged relationship being placed in proximity to the woman's hip area.

20. A method for utilizing a developmental device for use during and after pregnancy, the method comprising the steps of:
providing a developmental device comprising an elongated, reversible belt having a substantially uniform width, said belt having a first surface and a second surface, said belt further comprising at least one pocket attached to said first surface and at least one pocket attached to said second surface, said belt having oppositely disposed ends adapted to have an engaged position and a disengaged position; at least one speaker adapted to be selectively disposed within said pocket attached to said first surface, said speaker also adapted to be selectively disposed within said pocket attached to said second surface of said belt, said speaker emitting sounds toward a woman's abdomen; and, an audio playback device communicating with said speaker, said playback device operatively connected to said belt, said playback device comprising at least one microchip for transmitting an electrical signal to said speaker, said microchip having a plurality of musical songs and a plurality of nature sounds;
wrapping said belt around the woman's abdomen;
engaging the oppositely disposed ends of said belt the woman's hip area;
selecting one of the plurality of musical songs or one of the plurality of nature sounds on said playback device;
transmitting said electrical signal from said playback device to said speaker; and,
transmitting said selected song or nature sound to the fetus.

21. The method of claim 20, wherein said playback device further comprises a recordable microchip for recording a human voice.

22. The method of claim 21, further comprising the steps of:
recording a personalized message on said recordable microchip;
selecting said personalized message with said playback device; and,
transmitting said personalized message to the fetus.

23. A prenatal developmental device, comprising:
an elongated and elasticized belt having a substantially uniform width, said belt being reversible and having a first surface and a second surface, said belt having a first end and a second end, said first end adapted to attach to said second end such that said belt is snugly fit around the woman's abdomen, said first end attaching to said second end in a hip area of the woman, said width being no more than approximately two inches, said belt formed by two bands operative connected to each other;
at least two pockets attached to said first surface of said belt;
at least two pockets attached to said second surface of said belt;
at least two speakers adapted to be selectively disposed within said two pockets of said first surface, said two speakers also adapted to be selectively disposed within said two pockets attached to said second surface, said speakers emitting sounds toward a woman's abdomen to a fetus; and,
an audio playback device communicating with said speaker, said playback device selectively attachable to said belt, said playback device being no more than approximately two inches in length and no more than approximately two inches in width said playback device comprising:
at least one preprogrammed microchip and one recordable microchip for transmitting an electrical signal to said speaker, said preprogrammed microchip comprising a plurality of musical selections, a plurality of nature sounds, and a heartbeat sound, said recordable microchip adapted to record a human voice with a microphone disposed in said playback device;
an external speaker whereby a newborn infant can continue to hear similar sounds heard while in the woman's womb;
a jack for receiving earphones; and,
a LCD display for monitoring the audio selection and volume control.
